(19) United States
(12) Patent Application Publication
(10) Pub. No.: US 2023/0059751 A1
(43) Pub. Date: Feb. 23, 2023

(54) BATTERY MODULE

(71) Applicants: HYUNDAI MOTOR COMPANY, (US); KIA CORPORATION, (US)

(72) Inventor: Hyun Chang Kang, Seoul (KR)

(73) Assignees: HYUNDAI MOTOR COMPANY, Seoul (KR); KIA CORPORATION, Seoul (KR)

(21) Appl. No.: 17/742,748

(22) Filed: May 12, 2022

(30) Foreign Application Priority Data
Aug. 19, 2021 (KR) 10-2021-0109718

(51) Int. Cl. H01M 10/6557; H01M 10/613; H01M 50/204; H01M 10/625; H01M 50/271

(52) U.S. Cl. CPC H01M 10/6557; H01M 10/613; H01M 50/204; H01M 10/625; H01M 50/271; H01M 2220/20

(57) ABSTRACT

A battery module includes a battery layer formed by stacking a plurality of battery cells, a cartridge disposed in the battery cells of the battery layer and having channels through which air flows down, and battery covers disposed at sides of the battery layer and the cartridge. The battery covers are configured to laterally support the battery layer and the cartridge and are configured to change in length in accordance with the battery layer when the battery layer formed by stacking a plurality of battery cells is changed.

### CROSS-REFERENCE TO RELATED APPLICATION

The present application claims priority to Korean Patent Application No. 10-2021-0109718, filed Aug. 19, 2021, the entire contents of which are incorporated herein for all purposes by this reference.

### BACKGROUND

### Field of the Disclosure

The present disclosure relates to a battery module and, more particularly, to an air-cooling battery module in which cooling channels are integrated to reduce the number of parts of the battery module and to simplify the battery module.

### Description of the Related Art

Batteries that are used for vehicles are generally lithium-ion batteries. Further, automotive batteries are cooled in an air-cooling type, a water-cooling type, a refrigerant type, etc. The method of cooling a battery in the air-cooling type, which is a method of performing cooling by bringing an air pipe in direct contact with the atmosphere, has the advantage that there are no problems such as supplement, leakage, freezing, etc. of cooling water. The structure is simple and is easy to handle, so it is generally used for cooling automotive batteries.

Battery modules of the related art include a large number of parts for cooling the battery in the air-cooling type. The battery modules require many various parts, causing the assembly to be difficult and the battery modules to be complicated. The battery modules of the related art have another problem. When there is a problem with the modules, it is inconvenient and difficult to separately replace and repair a battery unit or a battery module.

Accordingly, it is required to reduce the number of parts of a battery module and simplify a battery module by adjusting the number of parts, adjusting the battery cells of a battery module, and integrating cooling channels through stacking of battery cells. It is also required to make it possible to separately replace and repair a battery unit or a battery module when there is a problem with the battery module.

The description provided above as a related art of the present disclosure is to help understand the background of the present disclosure. The foregoing description should not be construed as being included in the related art known by those having ordinary skill in the art.

### SUMMARY

The present disclosure can reduce the number of parts of a battery module and simplify a battery module by adjusting the number of parts, adjusting the battery cells of a battery module, and integrating cooling channels through stacking of battery cells. The present disclosure relates to a water-cooling battery module that makes it possible to separately replace and repair a battery unit or a battery module when there is a problem with the battery module.

In order to achieve the objects of the present disclosure, a battery module includes: a battery layer formed by stacking a plurality of battery cells; a cartridge disposed in the battery cells of the battery layer and having channels through which air flows down; and battery covers disposed at sides of the battery layer and the cartridge. The battery covers are configured to laterally support the battery layer and the cartridge and are configured to change in length in accordance with the battery layer when the battery layer formed by stacking a plurality of battery cells is changed.

The battery layer and the cartridge may be composed of two battery cells and one cartridge disposed between the two battery cells, respectively, thereby configuring a battery unit.

The battery covers may be changed in length in accordance with the battery layer when the battery layer is changed by changing an arrangement of a plurality of battery units.

The battery layer may be stacked by stacking a plurality of battery cells and inserting a cartridge between the battery cells.

Both ends of the cartridge may be fixed to the battery layer by a structure that is fitted to the battery cells.

Channels formed at the cartridge may include first channels formed in the cartridge and second channels that are formed when a plurality of cartridges is coupled.

Air may cool a battery while flowing down through the first channels between the battery cells. Air may cool battery cell taps formed at both ends of the battery cells while flowing down through the second channels.

Protrusions may be formed on sides of the cartridge. In each of the battery covers, grooves may be formed at an upper end, fixing portions for fixing the battery layer may be formed at a middle portion, and a power part may be formed at a lower end to be able to be connected to a battery through a power connection structure.

The battery covers may laterally support the battery layer and the cartridge by fitting protrusions on sides of the cartridge and grooves on upper ends of the battery covers.

The battery module may further include housings laterally supporting the battery layer and the cartridge and fixed to the battery covers to protect the battery cells.

The housings may have a shape covering the battery covers on an outside of the battery covers.

The battery module composed of the battery layer, the cartridge, the battery covers, and the housings may be fixed to a battery case by fixing-plates provided at both ends of the battery layer and bolts passing through the battery module.

The present disclosure can reduce the number of parts of a battery module and simplify a battery module by adjusting the number of parts, adjusting the battery cells of a battery module, and integrating cooling channels by stacking battery cells. It is also possible to separately replace and repair a battery unit or a battery module when there is a problem with the battery module.

The effects of the present disclosure are not limited to the effects described above. Other effects can be clearly understood by those having ordinary skill in the art from the following description.

### BRIEF DESCRIPTION OF THE DRAWINGS

The above and other objects, features, and other advantages of the present disclosure should be more clearly understood from the following detailed description when taken in conjunction with the accompanying drawings, in which:

FIG. 1 is a view showing a battery module of the related art;

FIG. 2 is a view showing a battery module according to an embodiment of the present disclosure;

FIG. 3 is a view showing a battery unit composed of two battery cells and one cartridge disposed between the two battery cells;

FIG. 4 is a view showing a first channel formed in the cartridge;

FIG. 5 is a view showing air flowing down to the first channel shown in FIG. 4;

FIG. 6 is a view showing a second channel formed in the cartridge;

FIG. 7 is a view showing air flowing down to the second channel shown in FIG. 6;

FIG. 8 is a view showing a battery layer and a cartridge that are laterally supported by fitting protrusions on a side of the cartridge and grooves on the upper end of a battery cover; and

FIG. 9 is a view showing a fixing-plate that is disposed on both ends of a battery layer and a battery module that is fixed to a battery case by bolts passing through the battery module.

### DETAILED DESCRIPTION

In the following description, the structural or functional description specified to embodiments according to the concept of the present disclosure is intended to describe the embodiments. Thus, it should be understood that the present disclosure may be variously embodied, without being limited to the embodiments. Hereinafter, embodiments of the present disclosure are described in detail with reference to the accompanying drawings.

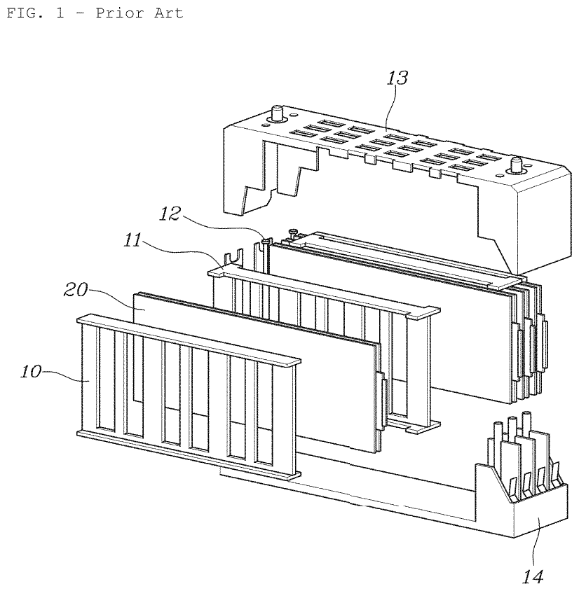

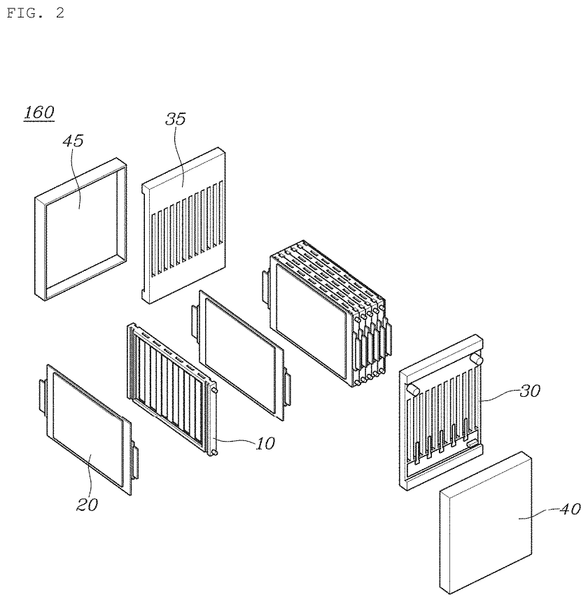

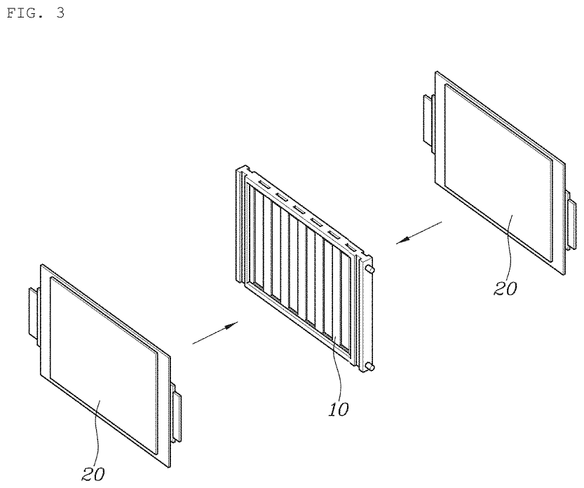

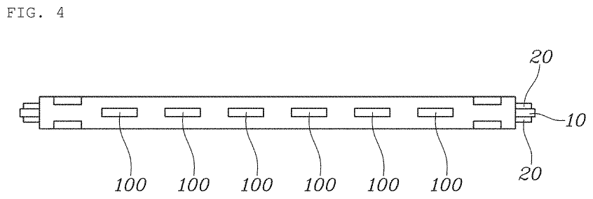

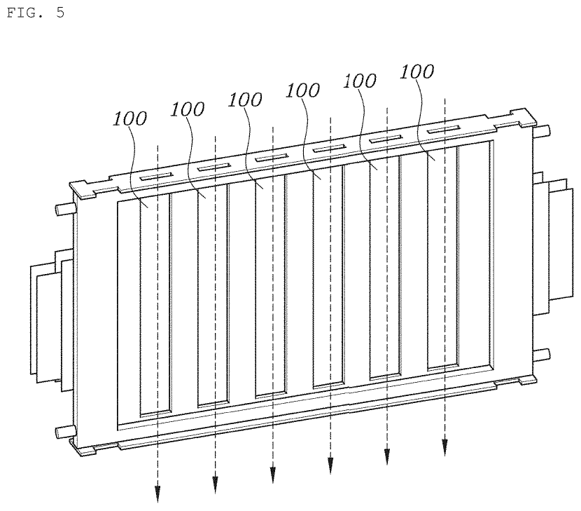

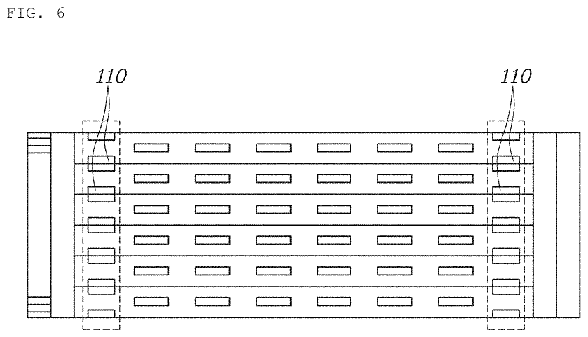

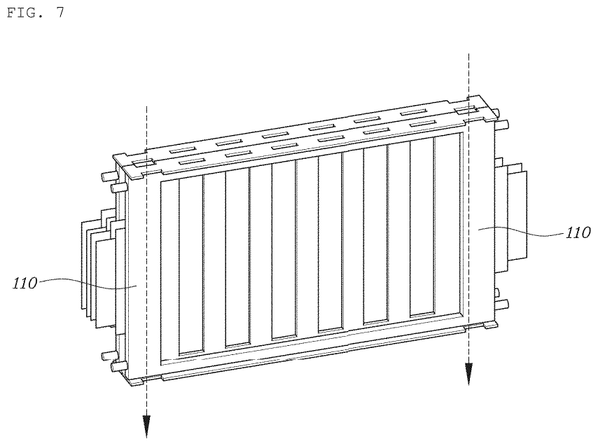

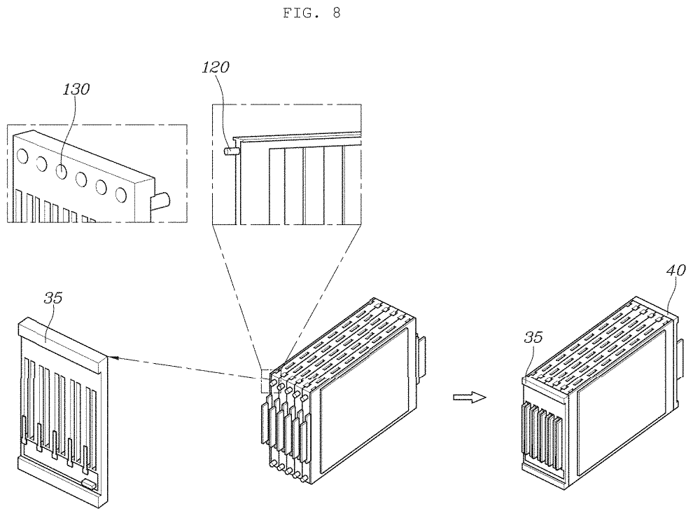

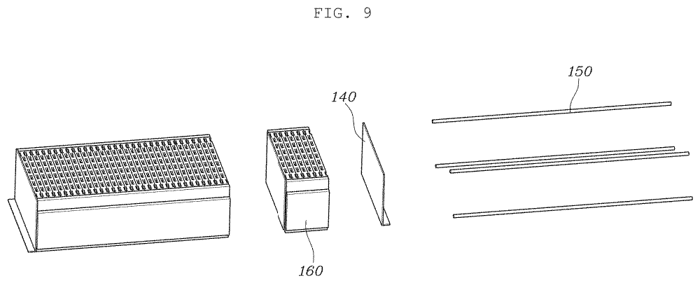

FIG. 1 is a view showing a battery module of the related art. FIG. 2 is a view showing a battery module according to an embodiment of the present disclosure. FIG. 3 is a view showing a battery unit composed of two battery cells and one cartridge disposed between the two battery cells. FIG. 4 is a view showing first channels formed at the cartridge. FIG. 5 is a view showing air flowing down through the first channels shown in FIG. 4. FIG. 6 is a view showing second channels formed at the cartridge. FIG. 7 is a view showing air flowing down through the second channels shown in FIG. 6. FIG. 8 is a view of a battery layer and cartridges that are laterally supported by fitting protrusions on sides of the cartridges and grooves on the upper end of a battery cover. FIG. 9 is a view showing a fixing-plate that is disposed on both ends of a battery layer and a battery module that is fixed to a battery case by bolts passing through the battery module.

FIG. 1 is a view showing a battery module of the related art. FIG. 2 is a view showing a battery module according to an embodiment of the present disclosure.

Referring to FIGS. 1 and 2, a battery module 160 includes: a battery layer composed of a plurality of stacked battery cells 20; a cartridge 10 disposed between the battery cells 20 of the battery layer and having channels for air to flow down; and battery covers 30 and 35 disposed at sides of the battery layer and the cartridge 10. The covers 30 and 35 laterally support the battery layer and the cartridge 10 and can change in length in accordance with the battery layer when the battery layer having the stacked battery cells 20 is changed.

According to the present disclosure, it is possible to reduce the number of parts of the battery module 160 and simplify the battery module 160 by adjusting the number of parts, adjusting the battery cells 20 of the battery module 160, and integrating cooling channels through stacking of the battery cells 20. It is also required to make it possible to separately replace and repair the battery unit or the battery module 160 when there is a problem with the battery module 160. To this end, the battery covers 30 and 35 should be disposed at sides of the battery layer and the cartridge 10, should laterally support the battery layer and the cartridge 10, and should change in length in accordance with the battery layer when the battery layer having the stacked battery cells 20 is changed. The method of cooling a battery in the air-cooling type, which is one of the methods of cooling an automotive battery, is a method of performing cooling by bringing an air pipe in direct contact with the atmosphere. The advantage is that there is no problem with supplement, leakage, freezing, etc. of cooling water. The structure is simple and easy to handle, so it is generally used for cooling automotive batteries.

According to the battery module 160 of the related art, since there are many parts and many kinds of parts to cool a battery in the air-cooling type, assembly is difficult. The battery module 160 is complicated, and it is inconvenient and difficult to separately replace and repair the battery unit or the battery module 160. Accordingly, it is desirable to reduce the number of parts of the battery module 160 and simplify the battery module 160 by adjusting the number of parts, adjusting the battery cells 20 of the battery module 160, and integrating cooling channels through stacking of the battery cells 20. It is also desirable to make it possible to separately replace and repair the battery unit or the battery module 160 when there is a problem with the battery module 160. Referring to FIG. 1, according to the battery module 160 of the related art, the cartridge 10, 11, and the battery cells 20 are disposed inside a top housing 13 and a bottom housing 14 that protect the battery cells 20. The cartridge 10, 11, is disposed between the battery cells 20, and the top housing 13, the bottom housing 14. The cartridge 10, 11 and the battery cells 20 are fixed by a housing fixer 12.

Accordingly, the battery covers 30 and 35 are configured to change in length in accordance with the battery layer when the battery layer having the stacked battery cells 20 is changed, in the present disclosure. This is so to reduce the number of parts of the battery module 160 and simplify the battery module 160 by adjusting the number of the parts, adjusting the battery cells 20 of the battery module 160, and integrating cooling channels through stacking of the battery cells 20.

In detail, the battery layer is configured by stacking a plurality of battery cells 20. A group of a plurality of battery cells constitutes the battery layer, and the battery cells 20 are lithium-ion batteries that are generally used for automotive batteries. The cartridge 10 is disposed between the battery cells 20 of the battery layer and has channels for air to flow down. The cartridge 10 is disposed between every battery cell 20 and is fixed by fixing portions formed at the battery covers 30 and 35. The battery covers 30 and 35 are disposed at sides of the battery layer and the cartridge 10, laterally support the battery layer and the cartridge 10, and change in length in accordance with the battery layer when the battery layer having the stacked battery cells 20 is changed. Housings 40 and 45 that protect the battery and are fixed to the battery covers 30 and 35 to protect the battery cells 20, cover the battery covers 30 and 35 on an outside of the battery covers.

FIG. 3 is a view showing a battery unit composed of two battery cells 20 and one cartridge 10 disposed between the two battery cells 20.

Referring to FIG. 3, the battery layer and the cartridge 10 are respectively composed of two battery cells 20 and one cartridge 10 disposed between the two battery cells 20, whereby a battery cell is configured.

Since the cartridge 10 is disposed between the battery cells 20, one cartridge 10 and two battery cells 20 are required to form a battery unit. Grooves are formed at the cartridge 10, so the battery cells 20 can be seated in position. When a battery unit is formed, the battery unit becomes one unit body, so it is possible to change a battery layer by changing the position of a plurality of battery units. When the battery unit is changed, unlike the battery module 160 of the related art, the battery covers 30 and 35 can be changed, so it is possible to reduce the number of parts of the battery module by adjusting the number of parts, adjusting the battery cells 20 of the battery module 160, and integrating cooling channels through stacking of the battery cells 20.

The battery covers 30 and 35 may be characterized by changing in length in accordance with the battery layer when the battery layer is changed by changing the arrangement of a plurality of battery units.

It is possible to form a plurality of battery units, each composed of two battery cells 20 and one cartridge 10 disposed between the two battery cells 20, and to change the arrangement of the battery units in accordance with required battery capacity. In this case, when the battery layers that are stacks of the battery cells 20 are changed, the length can be changed in accordance with the battery layer. Unlike the battery module 160 of the related art, when a specific battery unit breaks, it is possible to repair the battery covers 30 and 35 by replacing and assembling the battery unit with the problem.

The battery layer may be characterized in that it is stacked by stacking a plurality of battery cells 20 and inserting the cartridge between every battery cell 20.

The battery layer is formed by stacking a plurality of battery cells 20. Cooling channels for cooling the battery cells 20 stacked with the cartridge 10 therebetween and taps formed at both ends of the battery cells can be cooled. Since a plurality of battery cells 20 is arranged with the cartridge 10 therebetween, rather than being simply arranged and stacked, the efficiency of the method of cooling a battery in an air-cooling type can be maximally increased (e.g., optimized).

The cartridge 10 may be characterized in that both ends thereof are fixed to the battery layer by a structure that is fitted to the battery cells 20.

Referring to FIG. 3, the cartridge 10 is disposed between the battery cells 20 constituting the battery layer and it is required to keep the battery cells 20 stable by fixing the battery cells 20 and the cartridge 10. Accordingly, both ends of the cartridge 10 should be fitted to the battery cells 20 so that the cartridge 10 is fixed with the battery cells 20. Protruding portions of the battery cells 20 are fixed with the battery layer by fitting portions of the cartridge 10.

FIG. 4 shows first channels 100 formed at the cartridge 10. FIG. 5 is a view showing air flowing down through the first channels 100 shown in FIG. 4. FIG. 6 shows second channels 110 formed at the cartridge 10. FIG. 7 is a view showing air flowing down through the second channels 110 shown in FIG. 6.

The channels formed at the cartridge 10 may be characterized by including first channels 100 formed in the cartridge 10 and second channels 110 that are formed when a plurality of cartridges 10 are coupled.

FIGS. 4 and 5 show first channels 100 formed in a cartridge 10. FIGS. 6 and 7 show second channels 110 formed by coupling a plurality of cartridges 10. The first channels 100 can cool a battery cell 20 inside the second channels 110 and the second channels 110 can cool the battery cell taps, which are formed when a battery layer is formed, outside battery cells 20. Since the first channels 100 are formed in the cartridge 10, air-cooling channels are integrated in the cartridge 10 supporting battery cells 20. Accordingly, there is an effect that the total number of parts of the battery module 160 can be reduced and the battery module 160 is simplified.

Air cools a battery while flowing down through the first channels 100 between battery cells 20. Air also cools the battery cell taps formed at both ends of the battery cells while flowing down through the second channels 110.

The first channels 100 are positioned between a plurality of battery cells 20 constituting a battery layer to directly cool the battery cells 20. The second channels 110, which are cooling channels for battery cell taps, are provided to cool current collectors in the battery cells 20, thereby maximizing (e.g., optimizing) the effect of cooling the battery cells 20.

FIG. 8 is a view showing a battery layer and cartridges 10 that are laterally supported by fitting protrusions on sides of the cartridges 10 and grooves on the upper end of a battery cover 35.

Referring to FIG. 8, the present disclosure may be characterized in that protrusions 120 are formed on sides of the cartridge 10. In the battery covers 30 and 35, grooves 130 are formed at the upper ends, fixing portions are formed at the middle portions so that a battery layer can be fixed, and a power part is formed at the lower end to be able to be connected to a battery through a power connection structure.

The battery covers 30 and 35 are fixed to sides of the battery layer and the cartridge 10 by the protrusions 120 on sides of the cartridge 10 and the grooves 130 on the upper ends of the battery covers 30 and 35. A power connection structure is applied to both ends of the battery cell 20, so connecting portions for supplying power are formed. Accordingly, the battery layer can be fixed through the fixing portions at the middle portions of the battery covers 30 and 35. Power parts are formed at the lower ends of the battery covers 30 and 35 to transmit power that is supplied from both ends of the battery cell 20.

The battery covers 30 and 35 may be characterized by laterally supporting the battery layer and the cartridge 10 by fitting the protrusions 120 on sides of the cartridge 10 and the grooves 130 on the upper ends of the battery covers 30 and 35.

The battery covers 30 and 35 are fixed to sides of the battery layer and the cartridge 10 by the protrusions 120 on sides of the cartridge 10 and the grooves 130 on the upper ends of the battery covers 30 and 35. Accordingly, the battery covers 30 and 35, the battery layer, and the cartridge 10 can be prevented from shaking due to external shock and stability of the automotive battery can be secured or achieved.

The present disclosure may be characterized by further including housings 40 and 45 laterally supporting the battery layer and the cartridge 10 and fixed to the battery covers 30 and 35 to protect the battery cells 20.

The housings 40 and 45 are fixed to sides of the battery layer and the cartridge 10 and to the battery covers 30 and 35. Since the grooves 130, the fixing portions, and the power parts are provided at the upper end, the middle portion, and the lower end of the battery covers 30 and 35, respectively, if spaces are not closed, foreign substances may enter the battery and may cause a problem with the battery itself or the battery covers 30 and 35. Accordingly, it is required to employ the housings 40 and 45 in order to prevent foreign substances from laterally entering the battery layer and the cartridge 10 from the outside of the battery covers 30 and 35.

The housings 40 and 45 may be characterized by having a shape covering the battery covers 30 and 35 on an outside of the battery covers 30 and 35.

The housings 40 and 45 prevent foreign substances from laterally entering the battery layer and the cartridge 10 from the outside of the battery covers 30 and 35. It is possible to most efficiently prevent foreign substances from entering the inside when the housings 40 and 45 have a shape covering the battery covers 30 and 35 in all directions.

FIG. 9 is a view showing a fixing-plate 140 that is disposed on both ends of a battery layer and a battery module 160 that is fixed to a battery case by bolts passing through the battery module 160.

Referring to FIG. 9, a battery module 160 is composed of a battery layer, a cartridge 10, battery covers 30 and 35, and housings 40 and 45 and may be characterized by being fixed to a battery case by fixing-plates 140 provided at both ends of the battery layer and bolts 150 passing through the battery module 160.

The battery case has a space in which the battery module 160 is accommodated. When the battery module 160 is configured, the battery module 160 can be fixed to the battery case with the fixing-plates 140 at both ends of the battery layer. When the battery module 160 is long, bolts 150 that pass through the module may be added to firmly fix the battery module 160. When the battery module 160 is fixed by the fixing-plates 140 and the bolts 150, the battery module 160 can be integrally managed. Thus, there is an effect of reducing the number of parts of the battery module 160 and simplifying the battery module 160. When there is a problem, it is possible to separately replace and repair the battery unit or the battery module 160.

Although the present disclosure is described above in relation to specific embodiments shown in the drawings, it should be apparent to those having ordinary skill in the art that the present disclosure may be changed and modified in various ways without departing from the scope of the present disclosure, which is described in the following claims.

What is claimed is:

1. A battery module comprising:
a battery layer formed by stacking a plurality of battery cells;
a cartridge disposed in the battery cells of the battery layer and having channels through which air flows down; and
battery covers disposed at sides of the battery layer and the cartridge, the battery covers configured to laterally support the battery layer and the cartridge and configured to change in length in accordance with the battery layer when the battery layer, formed by stacking the plurality of battery cells, is changed.

2. The battery module of claim 1, wherein the battery layer and the cartridge are composed of two battery cells and one cartridge disposed between the two battery cells, respectively, thereby configuring a battery unit.

3. The battery module of claim 2, wherein the battery covers are changed in length in accordance with the battery layer when the battery layer is changed by changing an arrangement of a plurality of battery units.

4. The battery module of claim 1, wherein the battery layer is stacked by stacking the plurality of battery cells and inserting the cartridge between the battery cells.

5. The battery module of claim 1, wherein both ends of the cartridge are fixed to the battery layer by a structure that is fitted to the battery cells.

6. The battery module of claim 1, wherein the channels formed at the cartridge include first channels formed in the cartridge and second channels that are formed when a plurality of cartridges is coupled.

7. The battery module of claim 6, wherein air cools a battery while flowing down through the first channels between the battery cells, and wherein air cools battery cell taps formed at both ends of the battery cells while flowing down through the second channels.

8. The battery module of claim 1, wherein protrusions are formed on sides of the cartridge; and
in each of the battery covers, grooves are formed at an upper end, fixing portions for fixing the battery layer are formed at a middle portion, and a power part is formed at a lower end to be able to be connected to a battery through a power connection structure.

9. The battery module of claim 8, wherein the battery covers laterally support the battery layer and the cartridge by fitting protrusions on sides of the cartridge and the grooves on the upper ends of the battery covers.

10. The battery module of claim 1, further comprising housings laterally supporting the battery layer and the cartridge and fixed to the battery covers to protect the battery cells.

11. The battery module of claim 10, wherein the housings have a shape covering the battery covers on an outside of the battery covers.

12. The battery module of claim 10, wherein the battery module composed of the battery layer, the cartridge, the battery covers, and the housings is fixed to a battery case by fixing-plates provided at both ends of the battery layer and bolts passing through the battery module.
